(19) United States
(12) Patent Application Publication
(10) Pub. No.: US 2021/0350697 A1
(43) Pub. Date: Nov. 11, 2021

(54) METHOD FOR DRIVING MOBILE APPLICATION USING SOUND WAVE SIGNAL AND MOBILE APPLICATION DRIVING SYSTEM FOR IMPLEMENTING SAME

(71) Applicant: INFOSONIC INC., Seoul (KR)

(72) Inventor: Hoon Taek CHO, Seoul (KR)

(21) Appl. No.: 17/375,939

(22) Filed: Jul. 14, 2021

Related U.S. Application Data
(63) Continuation-in-part of application No. 16/073,339, filed on Nov. 12, 2018.

(30) Foreign Application Priority Data
Jan. 29, 2016 (KR) 10-2016-0011966

(51) Int. Cl. G08C 23/02

(52) U.S. Cl. CPC G08C 23/02; H04W 88/02

(57) ABSTRACT

According to an embodiment, in a method and system for driving a target application installed on a first terminal, a second terminal generates and transmits a sound wave driving signal to the first terminal. If the first terminal is positioned within a predetermined distance from the second terminal and is in a lock screen mode, an always-on application of the first terminal starts receiving the sound wave driving signal, so that the first terminal is unlocked. A driving signal is extracted from the received sound wave driving signal, and the target application, which matches application ID identification information contained in the extracted driving signal, may be automatically executed.

### CROSS-REFERENCE TO RELATED APPLICATION(S)

This application is a continuation-in-part of U.S. patent application Ser. No. 16/073,339, filed on Nov. 12, 2018, which is a national-stage application of International Patent Application No. PCT/KR2016/008109, filed on Jul. 25, 2016, which claims priority under 35 U.S.C. § 119 to Korean Patent Application No. 10-2016-0011966, filed on Jan. 29, 2016, in the Korean Intellectual Property Office, the disclosures of which are incorporated by reference herein in their entireties.

### TECHNICAL FIELD

The present invention relates to methods for driving mobile applications using sound wave signals and systems for driving mobile applications to implement the same, and more specifically, to schemes for immediately driving a particular application on a mobile terminal even when the mobile terminal remains locked by pushing a sound wave driving signal containing a driving signal to drive the particular application on the mobile terminal that is in a lock screen state.

### DISCUSSION OF RELATED ART

As ICT technology develops, modern people carry their mobile terminals all the time. Mobile terminals play a significant role in users' daily life. Smartphones are most frequently used mobile terminals. Smartphones may support various functions as well as their simple call functionality.

In general, users manipulate their smartphones on the touchscreen, The touchscreen may sometimes be accidentally touched, triggering a certain function. Thus, users set their phones to the lock screen when the phones are not in use.

FIG. 1 illustrates an embodiment of a mobile terminal that is in the lock screen mode. The user may unlock and use the smartphone 10 by entering a preset pattern onto the screen.

Conventionally, to release the lock screen mode (or to unlock the smartphone), the user needs to first enter a password or pattern to the smartphone. If the user has his hands full, such unlocking may be tricky.

Although succeeding in unlocking the screen, the user still needs to take more steps to be able to drive the application, such as finding and clicking on the icon associated with the application on the page where the icon is located. If there are many screens with applications and the application is not the one frequently used, the user may have difficulty and inconvenience in finding the application icon.

### SUMMARY

The present invention has been conceived to address the above problems with the prior art. According to the present invention, there is proposed a scheme that allows the user to immediately drive a desired application even without taking a special action when the mobile terminal, e.g., a smartphone, is in the lock screen mode.

In particular, the present invention may address such an issue where under the circumstance the smartphone is set to the lock screen mode, the user, upon desiring to drive a particular application, needs to first enter a password or pattern to unlock the smartphone, and if the user's hands are not free due to, e.g., holding some objects in his hands, such unlocking may be tricky.

Further, the present invention addresses the inconvenience that may arise when, despite succeeding in unlocking the screen, the user is required to take more steps to be able to drive the application, such as finding and clicking on the icon associated with the application on the page where the icon is located, and there are many screens with applications and the application is not the one frequently used.

To achieve the above objectives, according to the present invention, a method for driving a mobile application using a sound wave signal may comprise a sound wave driving signal transmitting step in which a second user terminal outputs a sound wave driving signal having a sound wave signal synthesized with a driving signal for driving an application; and an application driving step in which a first user terminal drives the application based on the sound wave driving signal.

According to an embodiment, the method may further comprise a sound wave driving signal generating step in which the second user terminal determines the application to be driven on the first user terminal, generates the driving signal to drive the application, and synthesizes the driving signal with the sound wave signal to generate the sound wave driving signal.

Or, the method may further comprise a sound wave driving signal generating step in which an online service server determines the application to be driven on the first user terminal, generates the driving signal to drive the application, synthesizes the driving signal with the sound wave signal, and transmits the sound wave driving signal to the second user terminal.

More preferably, the application driving step may include the steps of extracting the driving signal from the sound wave driving signal; determining the application to be driven based on the driving signal; and driving the application according to the driving signal.

Further, the sound wave driving signal transmitting step may include the steps of outputting, by the second user terminal, the sound wave driving signal through a speaker; and receiving, by the first user terminal, the sound wave driving signal through a microphone.

Still further, in the sound wave driving signal transmitting step, an always-on first sound wave driving-supporting application residing in the first user terminal may receive the sound wave driving signal through the microphone when the first user terminal is in a lock screen mode, and in the application driving step, the first sound wave driving-supporting application may release the lock screen mode and drive the application based on the sound wave driving signal.

Here, the sound wave signal may be a sound wave signal of an inaudible frequency bandwidth.

Or, the sound wave signal may be a melody or music sound.

According to the present invention, a system for driving a mobile application using a sound wave signal may comprise a second user terminal outputting a sound wave driving signal having a sound wave signal synthesized with a driving signal for driving an application; and a first user terminal driving an application equipped therein based on the sound wave driving signal output from the second user terminal

According to an embodiment, the first user terminal may include a sound wave driving signal receiver receiving the sound wave driving signal; a driving signal extractor extracting the driving signal from the sound wave driving signal; and an application driver driving the application based on the driving signal.

Further, the second user terminal may include a target application determiner determining an application to be driven on the first user terminal and generating the driving signal; a sound wave driving signal generator synthesizing the driving signal with the sound wave signal to generate the sound wave driving signal; and a sound wave driving signal output unit outputting the sound wave driving signal.

The system may further comprise an online service server, the online service server including a target application determiner determining an application to be driven on the first user terminal and generating the driving signal; a sound wave driving signal generator synthesizing the driving signal with the sound wave signal to generate the sound wave driving signal; and a sound wave driving signal transmitter transmitting the sound wave driving signal to the second user terminal. The second user terminal may receive the sound wave driving signal from the online service server and output the sound wave driving signal.

Still further, the first user terminal may be equipped with a first sound wave driving-supporting application to drive the application equipped therein based on the sound wave driving signal output from the second user terminal, and the second user terminal may be equipped with a second sound wave driving-supporting application to output the sound wave driving signal for driving the application.

Here, the first user terminal may be a portable mobile terminal.

According to an embodiment, a method for driving a target application installed on a first user terminal comprises outputting a sound wave driving signal from a second user terminal, the sound wave driving signal including a sound wave signal and a driving signal synchronized with each other, the driving signal including application identification (ID) information and additional information, receiving the sound wave driving signal by an always-on application installed on the first user terminal while a display of the first user terminal is in an on state and displays a lock screen, extracting the driving signal from the sound wave driving signal; determining the target application based on the driving signal, driving the target application based on the driving signal, and stopping receiving the sound wave driving signal when the display of the first user terminal is turned off or the lock screen is released.

The method may further comprise determining the target application by the second user terminal, generating the driving signal to drive the target application, and generating the sound wave driving signal by synthesizing the driving signal with the sound wave signal.

The method may further comprise determining the target application by an online server connected with the second user terminal, generating the driving signal to drive the target application, generating the sound wave driving signal by synthesizing the driving signal with the sound wave signal, and transmitting the sound wave driving signal to the second user terminal.

The always-on application may receive the sound wave driving signal through a microphone of the first user terminal when the first user terminal is in a lock screen mode and releases the lock screen mode and drives the application based on the sound wave driving signal.

The sound wave signal may be a sound wave signal in an inaudible frequency bandwidth.

The sound wave signal may be a melody or music sound.

According to an embodiment, a system for driving a target application via a sound wave driving signal comprises a first terminal having a first application and at least one second application installed thereon, the first application being an always-on application running on the first terminal while the first terminal is on, the at least one second application including the target application, and a second terminal transmitting the sound wave driving signal to the first terminal. The sound wave driving signal may include a carrier signal and a driving signal synchronized with each other, the driving signal including application identification (ID) information and additional information. The first terminal may include a display and a processor connected with the display and configured to receive the sound wave driving signal from the second terminal, extract the driving signal from the sound wave driving signal, determine the target application among the at least one second application, based on the application ID information included in the extracted driving signal, determine whether the display is on, determine whether the first terminal is in a lock screen mode, and switch the first terminal from the lock screen mode to an unlocked mode when receiving the sound wave driving signal.

The processor may be configured to receive the sound wave driving signal while the first terminal is in the lock screen mode.

The processor may be configured to stop receiving the sound wave driving signal when the display of the first terminal is turned off.

The target application may be an application matching the application ID information among the at least one second application.

The processor may be configured to allow the first terminal to stay in a standby mode unless the first terminal is in the lock screen mode and, when the display of the first terminal turns on to display the lock screen, release the standby mode to receive the sound wave driving signal.

The processor may be configured to turn the first terminal back to the standby mode based on at least one event of a turn-off of the display, a release of the lock screen mode, or execution of the target application.

According to the present invention, the user may immediately drive a desired application even without taking a special action when the mobile terminal, e.g., a smartphone, is in the lock screen mode.

In particular, the user may immediately drive his desired application even without performing such a procedure as entering a password or pattern to unlock the screen when the smartphone is in the lock screen mode. Thus, the user may drive the desired application even when the user has his hands full.

Further, the user may exactly drive his desired application without the need for finding and clicking an application icon difficult to do due to its infrequent use and turning a number of screens with many applications.

### BRIEF DESCRIPTION OF THE DRAWINGS

FIG. 1 illustrates an embodiment of a mobile terminal that is in a lock screen mode;

FIG. 2 illustrates an embodiment of a mobile application driving system using a sound wave signal according to the present invention;

FIG. 3 illustrates a configuration of an embodiment of a mobile application driving system using a sound wave signal according to the present invention.

FIGS. 4A and 4B are flowcharts illustrating a first embodiment of a mobile application driving method using a sound wave signal according to the present invention;

FIG. 5 is a flowchart illustrating a second embodiment of a mobile application driving method using a sound wave signal according to the present invention;

FIG. 6 illustrates a first implementation example of driving an application by a mobile application driving method using a sound wave signal according to the present invention;

FIG. 7 illustrates a second implementation example of driving an application by a mobile application driving method using a sound wave signal according to the present invention; and

FIG. 8 illustrates a third implementation example of driving an application by a mobile application driving method using a sound wave signal according to the present invention.

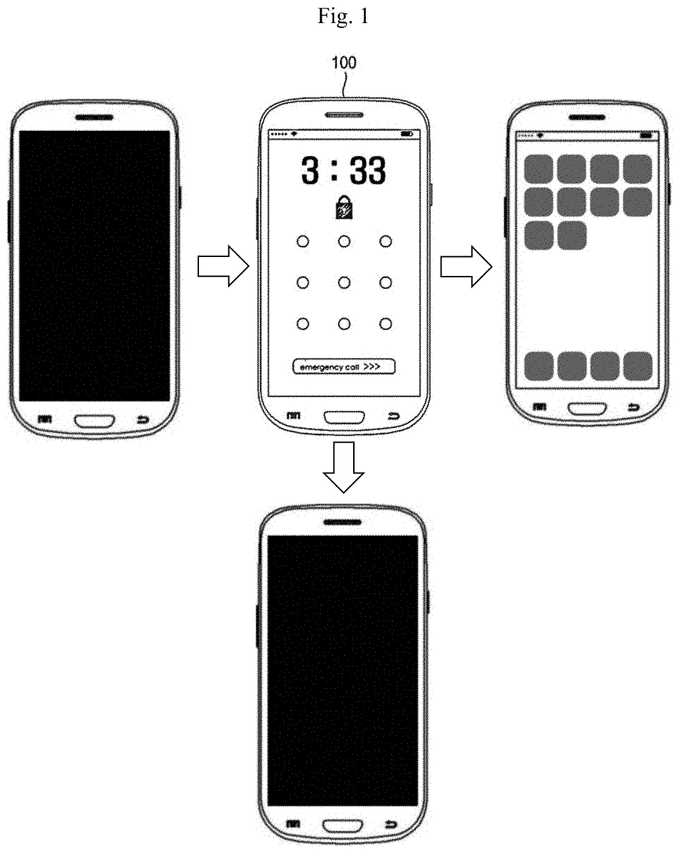

### DETAILED DESCRIPTION

The advantages and objects of the present invention will be apparent from the description of preferred embodiments of the present invention.

The terms used herein are provided simply to describe particular embodiments and are not intended to limit the scope of the present invention. As used herein, the singular forms “a,” “an,” and “the” are intended to include the plural forms as well, unless the context clearly indicates otherwise. It will be further understood that the terms “comprise” and/or “have,” when used in this specification, specify the presence of stated features, integers, steps, operations, elements, and/or components, but do not preclude the presence or addition of one or more other features, integers, steps, operations, elements, components, and/or groups thereof.

When determined to make the subject matter of the present invention unclear, the detailed description of the known configurations or functions may be skipped.

According to the present invention, there is proposed a scheme for being able to immediately drive a particular application on a mobile terminal even when the mobile terminal is in the lock screen mode by pushing a sound wave signal to drive the particular application.

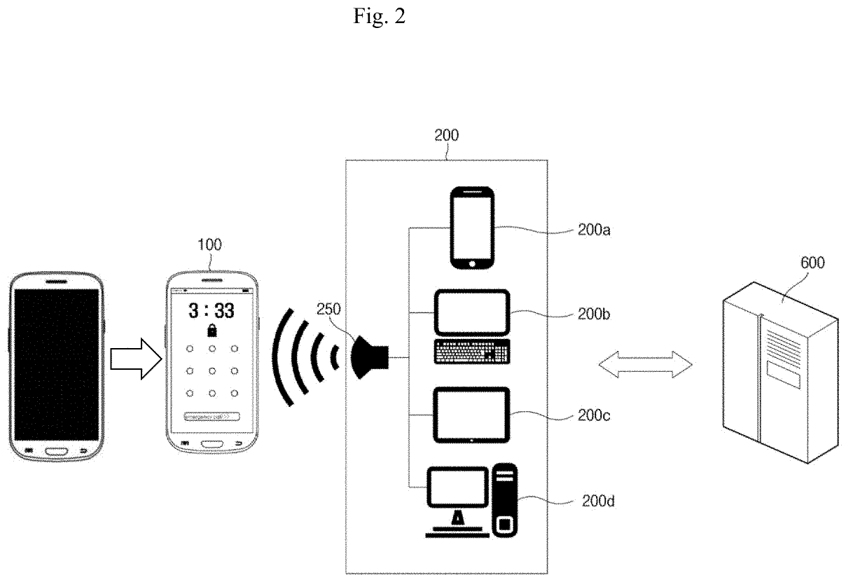

FIG. 2 illustrates an embodiment of a mobile application driving system using a sound wave signal according to the present invention.

According to the present invention, a mobile application driving system using a sound wave signal may include a first user terminal 100 and a second user terminal 200, and may, as necessary, include a server 600 for various online services, which supports relevant functions or information depending on applications driven.

The first user terminal 100 may be a smartphone, a tablet PC, or a common communication device that is widely used. In some contexts, the first user terminal 100 may be a separate terminal optimized to implement the present invention. According to an embodiment, the first user terminal 100 may be equipped with a first sound wave driving-supportive application that receives a sound wave driving signal, extracts information about the driving signal, and drives an application based on the extracted information.

The first user terminal 100 is a communication device that automatically drives the equipped application based on the sound wave driving signal. The first user terminal 100 may include a microphone to receive the sound wave driving signal and a component to extract the driving signal information combined with the sound wave driving signal

The first user terminal 100 may further include components to perform various functions as the application is driven. For example, where the application automatically driven is an authentication application, the first user terminal 100 may include a fingerprint recognition means that may store authentication information, such as a private key, pin number, or certificate available for authenticating the user and that may recognize user biometric information such as the user's fingerprint.

The second user terminal 200 is a device for automatically driving the application equipped in the first user terminal 100 using the sound wave driving signal, and the second user terminal 200 may include a means to output the sound wave driving signal for driving the application. As an example, the second user terminal 200 may be a smartphone 200a, a laptop computer 200b, a tablet PC 200c, or a PC 200d.

The second user terminal 200 may automatically drive the authentication application equipped in the first user terminal 100 using the sound wave driving signal to perform a process, e.g., authentication, required upon use of a particular online service. For example, where authentication is required upon using a mail service, game service, online shopping service, or financial service on the online service server, the second user terminal 200 may automatically drive the authentication application of the first user terminal 100 using the sound wave driving signal, allowing authentication to be performed on the online service server.

As such, according to the present invention, the application equipped in the first user terminal 100 may automatically be driven using the sound wave driving signal output from the second user terminal 200. In particular, where the first user terminal 100 is in the lock screen mode, a sound wave driving signal for driving a particular application may be transmitted, provided, or pushed to the first user terminal 100, allowing the particular application to immediately be driven although the user takes no separate action, such as unlocking the screen.

A detailed configuration thereof is described below in greater detail in connection with embodiments.

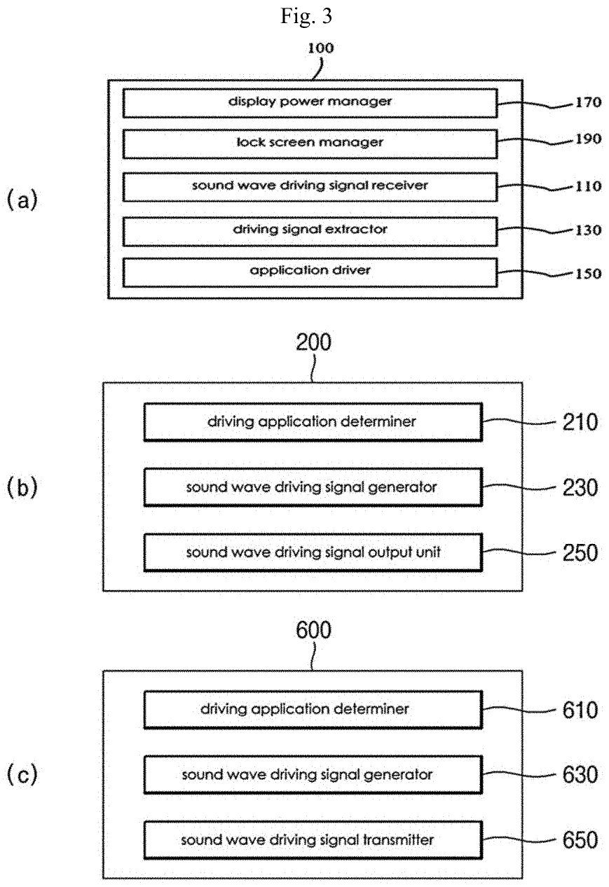

FIG. 3 illustrates a configuration of an embodiment of a mobile application driving system using a sound wave signal according to the present invention.

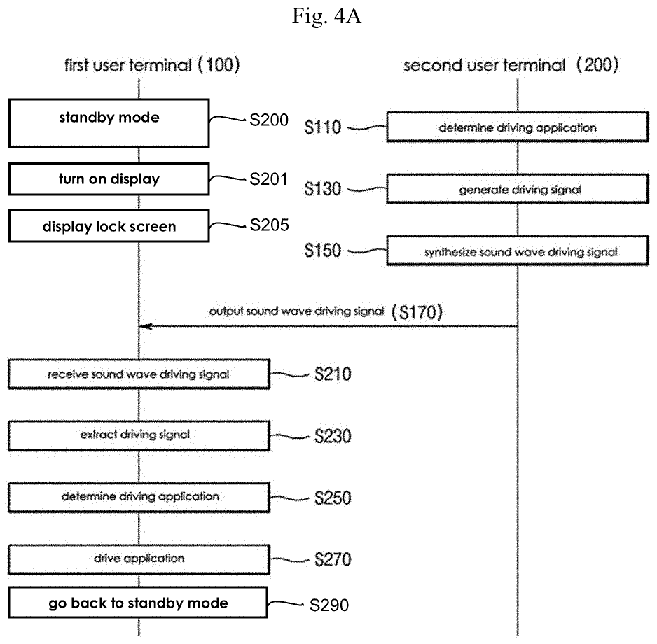

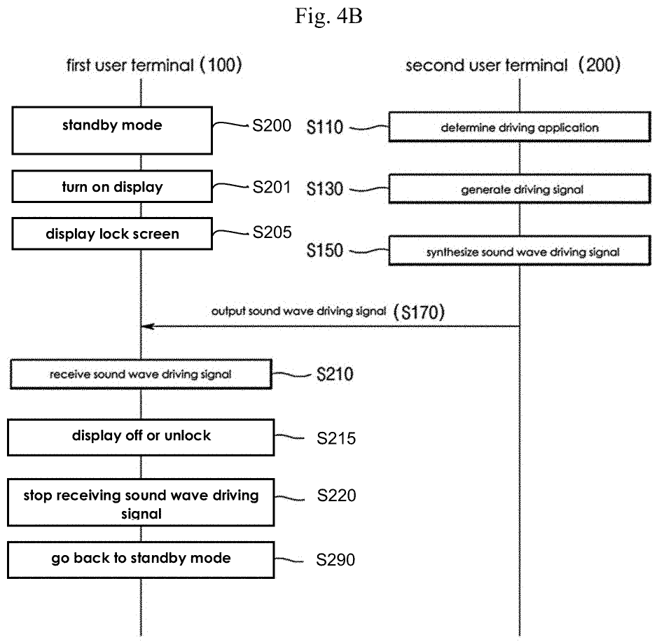

FIG. 4 is a flowchart illustrating an embodiment of a method for driving a mobile application using sound wave signals according to the present invention. FIG. 3(a) illustrates a configuration of the first user terminal 100, FIG. 3(b) illustrates a configuration of the second user terminal 200, and FIG. 3(c) illustrates a configuration of the online service server 600.

The first user terminal 100 is described with reference to FIG. 3(a). The first user terminal 100 may include a sound wave driving signal receiver 110, a driving signal extractor 130, an application driver 150, a display power manager 170, and a lock screen manager 190.

The sound wave driving signal receiver 110 may receive a sound wave driving signal from the second user terminal 200. To that end, the sound wave driving signal receiver 110 may include a microphone to receive the sound wave driving signal.

The driving signal extractor 130 extracts a driving signal from the received sound wave driving signal.

The application driver 150 drives an application based on the extracted driving signal. The application driver 150 determines application identification (ID) information contained in the driving signal and automatically drives the application based on the application identification information. In other words, the application driver 150 may drive an application corresponding to (or matching) the application ID information included in the driving signal. The display power manager 170 may determine whether the display of the first user terminal 100 is running (e.g., whether the display of the first user terminal 100 is in an on state). The lock screen manager 190 may determine whether the lock screen of the first user terminal 100 is running (e.g., whether the lock screen of the first user terminal 100 is being displayed on the display of the first user terminal 100).

Although FIG. 3(a) illustrates the first user terminal 100 as if the components of the first user terminal 100 are individually provided, the components of the first user terminal 100 may be implemented as a first sound wave driving-supporting application configured to perform the above-described functions and operations of the components, and the first sound wave driving-supporting application may be installed on the first user terminal 100. Alternatively, the components of the first user terminal 100 may be implemented as circuitry, a controller, or processor configured to perform the above-described functions and operations of the components, or may be controlled by a process (not shown) included in the first user terminal 100. The first sound wave driving-supporting application may be an always-on application running on the first user terminal 100. If a display of the first user terminal 100 turns on and displays a lock screen, the first sound wave driving-supporting application may start to receive the sound wave driving signal and, if the display of the first user terminal 100 turns off or the lock screen is released by, e.g., the user, the first sound wave driving-supporting application may stop receiving the sound wave driving signal.

The second user terminal 200 is described with reference to FIG. 3(b). The second user terminal 200 may include a target application determiner 210, a sound wave driving signal generator 230, and a sound wave driving signal output unit 250.

The target application determiner 210 determines an application to be driven on the first user terminal 100 (which may also be simply referred to herein as a ‘target application’) and generates a driving signal. In this case, the target application determiner 210 may determine the target application according to the user's selection or according to information required by an online service server connected with the second user terminal 200.

The sound wave driving signal generator 230 synthesizes a sound wave signal with the driving signal generated by the target application determiner 210, thereby generating a sound wave driving signal. In other words, the sound wave driving signal may be a mix or a synthesized signal of the sound wave signal and the driving signal. The sound wave signal may serve as a carrier for the driving signal. The driving signal may include application ID information for the target application. The driving signal may further include other various information. The sound wave driving signal generator 230 may generate the sound wave driving signal by synthesizing the sound wave signal with the driving signal, with the sound wave signal and the driving signal synchronized with each other. In other words, upon synthesis of the sound wave driving signal, the driving signal may be synchronized with the sound wave signal.

The sound wave signal is a reference signal for synthesizing the sound wave driving signal. The first user terminal 100 and the second user terminal 200 may previously have the sound wave signal or information about the sound wave signal (e.g., frequency information or amplitude information for the sound wave signal). The sound wave signal is a signal playing a similar role to the carrier wave of wireless communication technology. Since a sound wave signal previously agreed on or shared between the first user terminal 100 and the second user terminal 200 is used when the first user terminal 100 receives the sound wave driving signal from the second user terminal 200, the first user terminal 100 may easily extract the driving signal from the sound wave driving signal.

The sound wave driving signal output unit 250 outputs the sound wave driving signal generated by the sound wave driving signal generator 230. To that end, the sound wave driving signal output unit 250 may include, e.g., a speaker to output the sound wave driving signal.

Although FIG. 3(b) illustrates the second user terminal 200 as if the components of the second user terminal 200 are individually provided, the components of the second user terminal 200 may be implemented as a second sound wave driving-supporting application configured to perform the above-described functions or operations of the components, and the second sound wave driving-supporting application may be installed on the second user terminal 200. Alternatively, the components of the second user terminal 200 may be implemented as circuitry, a controller, or a processor configured to perform the above-described functions or operations of the components, or may be controlled by a process (not shown) included in the second user terminal 200

Alternatively, the second user terminal 200 may, rather than generating the sound wave driving signal on its own, receive a sound wave driving signal from the online service server 600 and output the received sound wave driving signal. The online service server 600 to provide the sound wave driving signal is described below with reference to FIG. 3(c).

The online service server 600 may include a target application determiner 610, a sound wave driving signal generator 630, and a sound wave driving signal transmitter 650.

The target application determiner 610 determines a target application and generates a driving signal to drive the target application when requested by the second user terminal 200. In this case, the target application determiner 610 may determine the target application by identifying an application for performing, e.g., authentication, when the second user terminal 200 uses an online service provided from the online service server 600 or selection information about the user's selection of the application to be driven on the first user terminal 100.

The sound wave driving signal generator 630 synthesizes a sound wave signal with the driving signal generated by the target application determiner 610, thereby generating a sound wave driving signal. The sound wave driving signal generator 230 may generate the sound wave driving signal by synthesizing the sound signal with the driving signal, with the sound signal and the driving signal synchronized with each other.

As set forth above, the sound signal is a reference signal for synthesizing a sound wave driving signal. The online service server 600 may previously have the sound signal or (various types of) information (e.g., frequency or amplitude) about the sound signal. The sound wave signal is a signal playing a similar role to the carrier wave of wireless communication technology. Since a sound wave signal previously agreed on is used, the first user terminal 100 may easily extract the driving signal from the sound wave driving signal.

The sound wave driving signal transmitter 650 transmits the sound wave driving signal generated by the sound wave driving signal generator 630 to the second user terminal 200.

According to the present invention, there is also provided a method for automatically driving a mobile application by a sound wave driving signal via a mobile application driving system as described above. According to the present invention, a method for driving a mobile application using a sound wave signal may briefly include a sound wave driving signal transmitting step in which the second user terminal outputs a sound wave driving signal obtained by synthesizing a sound wave signal with a driving signal for driving an application and an application driving step in which the first user terminal drives the application based on the sound wave driving signal.

A method for driving a mobile application using a sound wave signal, according to the present invention, is described below.

FIGS. 4A and 4B are flowcharts illustrating a first embodiment of a mobile application driving method using a sound wave signal according to the present invention.

Referring to FIGS. 4A and 4B, the second user terminal 200 determines an application to be driven on the first user terminal 100 (i.e., a target application) (S110). In this case, the target application may be determined by the user's selection or based on information requested by the online service server 600 to which the second user terminal 200 is connected.

When the target application is determined, the second user terminal 200 generates a driving signal to drive the target application (S130). In this case, the driving signal may contain identification information about the application (e.g., an application ID) and may further include the information required by the online service server 600.

The second user terminal 200 generates a sound wave driving signal by synthesizing the driving signal with a sound wave signal (S150). In this case, the driving signal may be synchronized, in period or start position, with the sound wave signal, so that the driving signal may be extracted from the sound wave driving signal. Here, any frequency bandwidth of signal, which is capable of being combined with data and transmitted, may be adopted as the sound wave signal. For example, an inaudible frequency bandwidth of signal may be used as the sound wave signal to avoid the user from feeling the sound wave signal as noise or being annoyed by the sound wave signal. For example, a melody or music sound may be used as the sound wave signal.

When the sound wave driving signal is generated, the second user terminal 200 outputs the generated sound wave driving signal (S170). To that end, the second user terminal 200 may include, e.g., a speaker to output the sound wave driving signal, and the second user terminal 200 outputs the sound wave driving signal through the speaker.

The first user terminal 100 drives or turns on its display (S201) and displays a lock screen on the display (S205). In this case, the first sound wave driving-supporting application installed on the first user terminal 100 may be in a state of waiting without receiving a sound wave driving signal until the lock screen is displayed on the display of the first user terminal 100 (S200) and, if the lock screen is displayed, the first sound wave driving-supporting application may turn into a state in which it may receive a sound wave driving signal and perform its subsequent operations (e.g., extraction of driving signal, determination of the target application, and driving the target application). The state of waiting without receiving a sound wave driving signal may be referred to herein as a “standby mode.” In other words, the first sound wave driving-supporting application does not perform reception of a sound wave driving signal while the first user terminal 100 is not in the lock screen mode. For example, when the first user terminal is in the lock screen mode, the first sound wave driving-supporting application may be triggered to start receiving a sound wave driving signal and, if the display of the first user terminal is turned off, or the lock screen mode is released, the first sound wave driving-supporting application stops receiving a sound wave driving signal. The sound wave driving signal output from the second user terminal 200 is received by the first user terminal 100 (S210). For smooth or seamless receipt of the sound wave driving signal, the first user terminal 100 may be positioned within a predetermined range of the second user terminal 200. The first user terminal 100 may include, e.g., a microphone, and the first user terminal 100 may receive the sound wave driving signal from the second user terminal 200 via the microphone.

Referring to FIG. 4A, unless the display of the first user terminal 100 is turned off or the lock screen is released, the first user terminal 100 extracts the driving signal from the received sound wave driving signal (S230). When the driving signal is extracted, the first user terminal 100 determines the target application based on the driving signal (S250). As described above, as the driving signal contains the application ID information, the first user terminal 100 may determine the target application based on the application ID information contained in the driving signal.

The first user terminal 100 drives the application, which is determined based on the identification information, according to the driving signal (S270). In this case, in addition to the application ID information, the driving signal may include other various pieces of information (which may be referred to herein as ‘additional information’). The first user terminal 100 may automatically input the additional information contained in the driving signal to the running application, thereby allowing the application to perform various functions or operations. Then, the first terminal may go back to the standby mode (S290). In contrast to the embodiment shown in FIG. 4A, if the display of the first user terminal 100 is turned off or the lock screen of the first user terminal 100 is released (S215), the first user terminal 100 stops receiving the sound wave driving signal (S220). For example, if the display of the first user terminal 100 is turned off or the lock screen of the first user terminal 100 is released (S215), the first sound wave driving-supporting application may stop receiving the sound wave driving signal (S220). Then, the first user terminal may go back to the standby mode (S290). In other words, reception of a sound wave driving signal is performed in the lock screen mode, but not in the display-off mode (i.e., when the display stays off) or unlocked mode. This way may prevent the first user terminal from performing unnecessary operations while saving power.

The first user terminal 100 may receive the sound wave driving signal from the second user terminal 200 while the first user terminal 100 is in the lock screen mode. For example, an application, which is installed on the first user terminal 100 and remains running on the first user terminal 100, (this application is referred to as an ‘always-on application’) may recognize the sound wave driving signal transmitted from the second user terminal 200. For example, even in the lock screen mode, the first user terminal 100 may receive the sound wave driving signal, and the always-on application may unlock the screen of the first user terminal 100 by recognizing the sound wave driving signal, thereby allowing the application to be automatically driven.

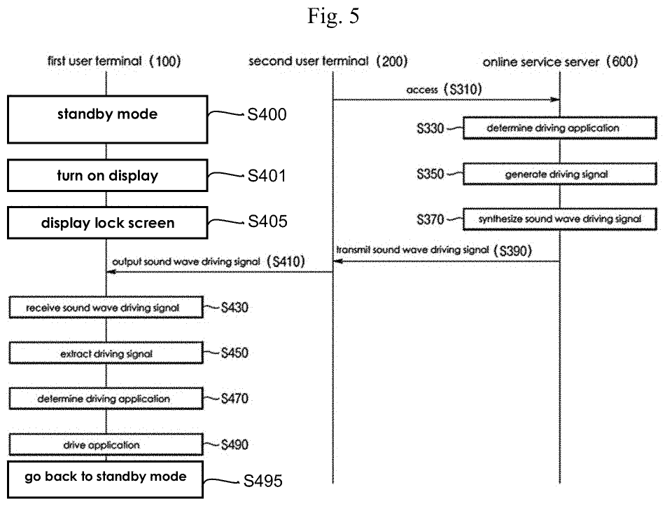

The second user terminal 200 may receive the sound wave driving signal from the online service server 600 and output the received sound wave driving signal. FIG. 5 is a flowchart illustrating a second embodiment of a method for driving a mobile application using a sound wave signal according to the present invention.

When the second user terminal 200 accesses the online service server 600 (S310), the online service server 600 determines an application to be driven on the first user terminal 100 (i.e., a target application) (S330). In this case, the target application may be determined to be an application selected by the user or may be determined based on information necessary to allow the second user terminal 200 to use the service provided from the online service server 600.

When the target application is determined, the online service server 600 generates a driving signal to drive the target application (S350). In this case, the driving signal may contain application ID information about the target application and information required by the online service server 600.

The online service server 600 generates a sound wave driving signal by synthesizing the driving signal with a sound wave signal (S350). In this case, the driving signal may be synchronized, in period or start position, with the sound wave signal, so that the driving signal may later be extracted from the sound wave driving signal. Here, any frequency bandwidth of signal, which is capable of being combined with data and transmitted, may be adopted as the sound wave signal. For example, an inaudible frequency bandwidth of signal may be used as the sound wave signal to avoid the user from feeling the sound wave signal as noise or being annoyed by the sound wave signal. For example, a melody or music sound may be used as the sound wave signal.

When the sound wave driving signal is generated, the online service server 600 transmits the sound wave driving signal to the second user terminal 200 (S390).

The second user terminal 600 outputs the sound wave driving signal received from the online service server 600 (S410). To that end, the second user terminal 200 may include, e.g., a speaker to output the sound wave driving signal, and the second user terminal 200 outputs the sound wave driving signal through the speaker.

The first user terminal 100 drives or turns on its display (S401) and displays a lock screen on the display (S405). In this case, the first user terminal 100 may be in the standby mode in which the first user terminal 100 (or the first sound wave driving-supporting application installed on the first user terminal 100) waits without receiving a sound wave driving signal. The sound wave driving signal output from the second user terminal 200 is received by the first user terminal 100 (S430). For smooth or seamless receipt of the sound wave driving signal, the first user terminal 100 may be positioned within a predetermined range of the second user terminal 200. The first user terminal 100 may include, e.g., a microphone, and the first user terminal 100 may receive the sound wave driving signal from the second user terminal 200 via the microphone. According to an embodiment, if the display of the first user terminal 100 is turned off or the lock screen of the first user terminal 100 is released, the first user terminal 100 may stop receiving the sound wave driving signal.

The first user terminal 100 extracts the driving signal from the received sound wave driving signal (S450). To that end, the first user terminal 100 extracts the driving signal from the sound wave driving signal by synchronizing the sound wave driving signal with the sound wave signal.

When the driving signal is extracted, the first user terminal 100 determines the target application based on the driving signal (S470). As described above, the driving signal contains the application ID information about the target application. The first user terminal 100 may determine the target application based on the application ID information contained in the driving signal.

The first user terminal 100 drives the determined target application, according to the driving signal (S490). In this case, in addition to the application ID information, the driving signal may include other various pieces of information (i.e., additional information). The first user terminal 100 may automatically input the additional information contained in the driving signal to the application, thereby allowing the application to perform its functions or operations. Then, the first user terminal 100 may go back to the standby mode (S495).

The automatic driving of an application using a sound wave signal as described above may have various applications. For example, for user authentication, an authentication application installed on the first user terminal 100 may be automatically driven by a sound wave driving signal.

Various implementation examples to which a method for driving a mobile application using a sound wave signal according to the present invention is applicable are described below.

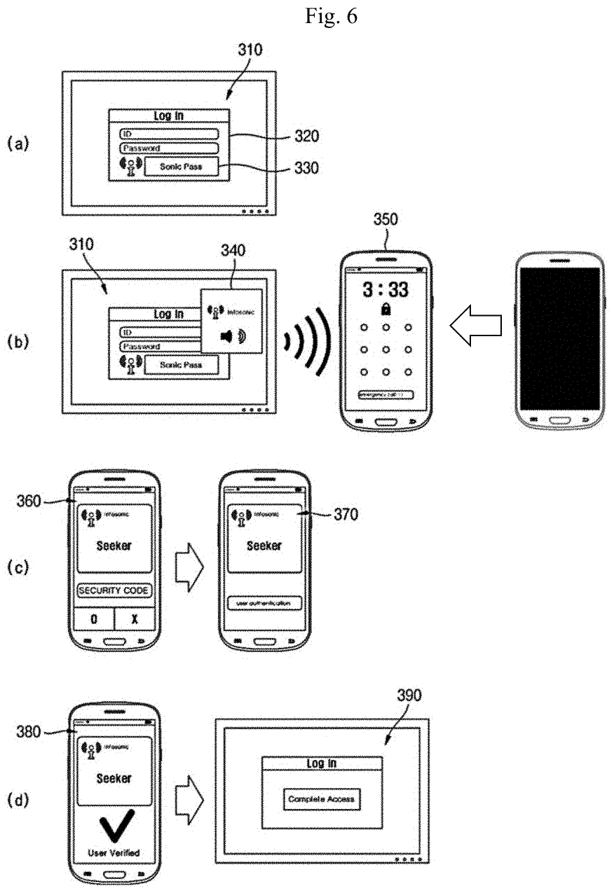

FIG. 6 illustrates a first implementation example of driving an application by a mobile application driving method using a sound wave signal according to the present invention.

Where the second user terminal is requested for user authentication, e.g., log-in, as a service authority request to be able to use online service upon accessing the online service server, a log-in window 320 pops up on the screen 310 of the second user terminal as shown in FIG. 6(a). At this time, there may also be shown a sonic path icon 330 to apply the mobile application driving method according to the present invention.

When the user selects the sonic path icon 330 on the second user terminal, the second user terminal generates and outputs a sound wave driving signal to drive an authentication application to perform user log-in and, as shown in FIG. 6(b), a sound wave signal transmission window 340 is shown on the screen 310 of the second user terminal to indicate that the sound wave driving signal is being transmitted.

In this case, the sound wave driving signal output from the second user terminal includes a driving signal synthesized with a sound wave signal to automatically drive the authentication application. The driving signal may contain identification information about the authentication application, and the driving signal may further include additional information for performing authentication, e.g., session information for performing the authentication process. For example, the additional information may include information for requesting to automatically enter the user authentication information to the second user terminal or a uniform resource locator (URL) related to the authentication process of the online service server 600.

When the sound wave signal transmission window 340 is shown on the second user terminal, the user may position the authentication application-installed first user terminal 100 to be able to receive the sound wave driving signal. At this time, the first user terminal may be in the lock screen mode 350 as shown in FIG. 6(b). In other words, the first user terminal may turn on the display and display the lock screen on the display.

The first user terminal receives the sound wave driving signal from the second user terminal, extracts the driving signal from the sound wave driving signal, and automatically drives the authentication application as per the driving signal. As shown in FIG. 6(c), the lock screen of the first user terminal is released by the sound wave driving signal, the authentication application is driven, and the authentication execution screen 360 of the authentication application is shown. The user performs user authentication via the user authentication screen 370 of the authentication application automatically driven on the first user terminal. Although not shown in FIG. 6(c), the user authentication process may be carried out by, e.g., password entry or biometric recognition.

The authentication application of the first user terminal performs the user authentication process and transmits a result thereof. The result of authentication may be transmitted to the second user terminal. Alternatively, in a case where the sound wave driving signal transmitted from the second user terminal contains URL information for authentication to the online service server, the authentication application may directly provide the result of authentication to the online service server.

When the user authentication on the first user terminal succeeds, an authentication success screen 380 is shown on the first user terminal as shown in FIG. 6(d), and automatic log-in to the online service server is done for the second user terminal where the user requests online service, and a log-in complete screen 390 is shown on the second user terminal, and the second user terminal accesses the online service server as per the authentication complete information.

As such, the user may automatically perform authentication on various online service servers by the method for driving a mobile application using a sound wave signal according to the present invention.

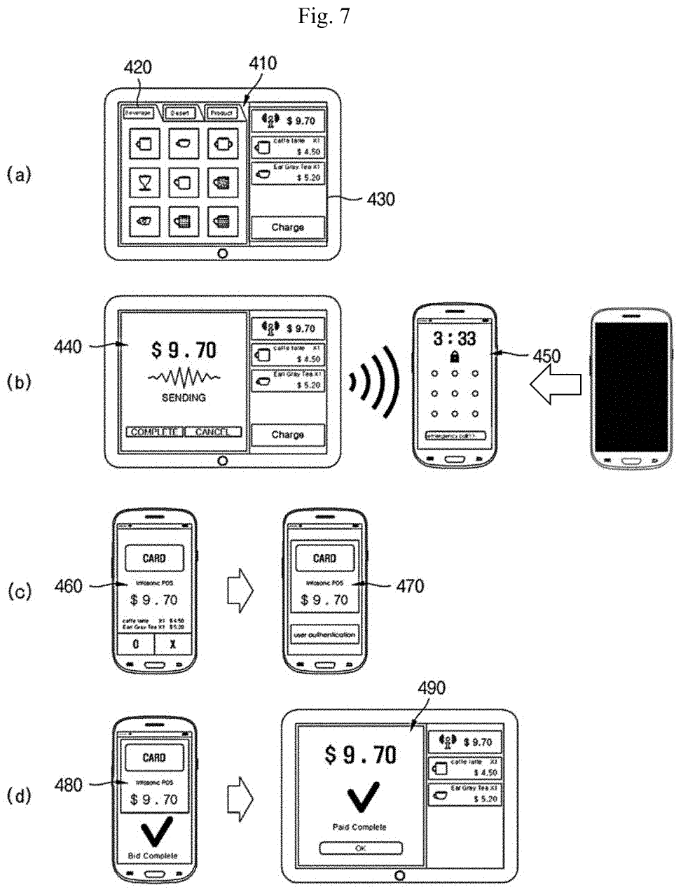

FIG. 7 illustrates a second implementation example of driving an application by a mobile application driving method using a sound wave signal according to the present invention.

FIG. 7 illustrates an implementation example in which a payment application of a mobile terminal is automatically driven with a sound wave driving signal upon payment via a shop's POS terminal. Referring to FIG. 7(a), a product 420 is selected, and a payment request window 430 for the selected product is shown on the screen 410 of the second user terminal, which is the POS terminal. When payment is made on the payment request window 430, a sound wave driving signal transmission window 440 is shown on the screen of the second user terminal which is the POS terminal. At this time, the sound wave driving signal may include application ID information about a payment application and additional information, e.g., product payment information, in a driving signal, and the driving signal may be synthesized with a sound wave signal, forming a sound wave driving signal. The PoS terminal includes the components of the second user terminal 100 described above in connection with FIG. 3.

When a sound wave driving signal transmission window 440 is shown on the screen of the second user terminal, the buyer puts his first user terminal in a position where it can receive the sound wave driving signal in which case the first user terminal may be in the lock screen mode 450 as shown in FIG. 7(b). In other words, the first user terminal may turn on the display and display the lock screen on the display.

When the first user terminal receives the sound wave driving signal from the second user terminal, the lock screen of the first user terminal is automatically released, and the payment application is automatically driven by the driving signal contained in the sound wave driving signal as shown in FIG. 7(c).

As shown in FIG. 7(c), the buyer selects the amount of payment and the payment means, e.g., credit card, on the screen 460 of the payment application driven on the first user terminal and then performs user authentication on the user authentication screen 470. Although FIG. 7(c) is schematically illustrated for ease of description, the user authentication for payment may be performed via various processes, e.g., password entry or biometric recognition, and the payment application may perform the authentication process by accessing the bank server, credit card company server, or VAN server.

When the user authentication is complete, an authentication complete screen 480 is shown on the first user terminal as shown in FIG. 7(d). If the payment is complete by the payment application of the first user terminal, the payment complete screen 490 is shown on the second user terminal which is the POS terminal.

As such, the user may automatically perform authentication for, e.g., various payment services by the method for driving a mobile application using a sound wave signal according to the present invention.

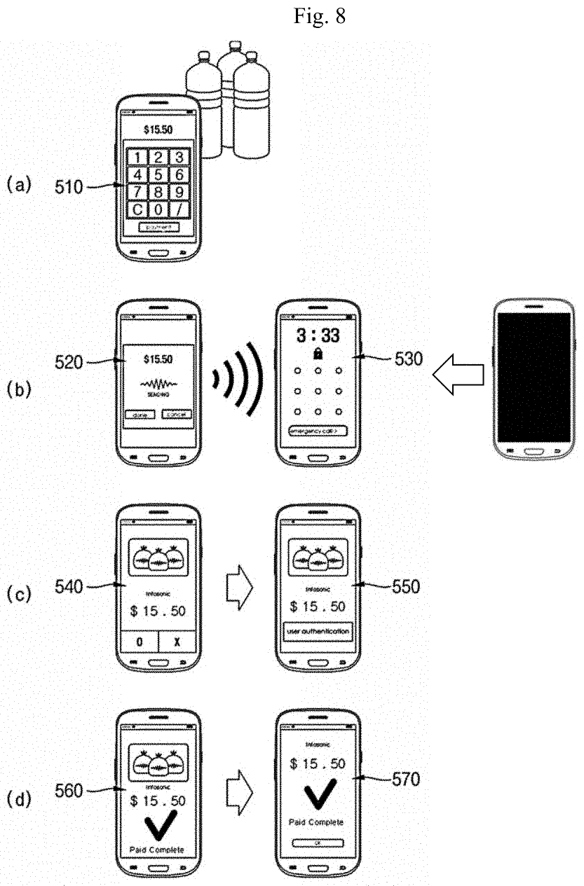

FIG. 8 illustrates a third implementation example of driving an application by a mobile application driving method using a sound wave signal according to the present invention. Similar to the second implementation example described above in connection with FIG. 7, the third implementation example of FIG. 8 regards performing payment by automatically driving a payment application with a sound wave driving signal. In the third implementation example, however, a mobile terminal, instead of the POS terminal, is used as the second user terminal for performing the payment process.

As shown in FIG. 8(a), a shop clerk enters, to the screen 510 of his smartphone (i.e., the second user terminal), the price of the product that the buyer purchases. The second user terminal has a product payment application installed thereon.

When the price of the product is entered via the product payment application to the second user terminal, and thus, a sound wave driving signal output window 520 shows up for payment request as shown in FIG. 8(b), the buyer puts his first user terminal in a position where it can receive the sound wave driving signal in which case the first user terminal may be in the lock screen mode 530 as shown in FIG. 8(b). In other words, the first user terminal may turn on the display and display the lock screen on the display.

When the first user terminal receives the sound wave driving signal from the second user terminal, the lock screen is automatically released, and the payment application is automatically driven by the driving signal contained in the sound wave driving signal, thereby allowing a payment application screen 540 to show up as shown in FIG. 8(c). At this time, as described above in connection with the second implementation example of FIG. 7, the payment information is shown on the first user terminal, so that the user performs user authentication on the user authentication screen 550 for payment.

When user authentication is performed on the first user terminal, an authentication complete screen 560 is shown on the first user terminal as shown in FIG. 8(d). As the payment is complete by the payment application of the first user terminal, a payment complete screen 570 is shown on the second user terminal.

As such, the mobile application driving method of the present invention allows the user to automatically perform authentication for, e.g., various payment services on various types of portable terminals, not only POS terminals.

According to the present invention, the user may immediately drive a desired application even without taking a special action when the mobile terminal, e.g., a smartphone, is in the lock screen mode.

In particular, the user may immediately drive his desired application with a sound wave driving signal even without performing such a procedure as entering a password or pattern to unlock the screen when the smartphone is in the lock screen mode. Thus, the user may drive the desired application even when the user has his hands full.

Further, the user may exactly drive his desired application without the need for finding and clicking an application icon difficult to do due to its infrequent use and turning a number of screens with many applications.

According to an embodiment, a system for driving a target application via a sound wave driving signal comprises a first terminal (e.g., the first user terminal 100) and a second terminal (e.g., the second user terminal 200). The first terminal may have a first application (e.g., the always-on application) and at least one second application installed thereon. The first application may be an always-on application running on the first terminal while the first terminal is on. The at least one second application includes the target application. The second terminal generates and transmits the sound wave driving signal to the first terminal. The sound wave driving signal include a carrier signal (e.g., the sound wave signal) and a driving signal synchronized with each other, e.g., in period or start position. The driving signal includes application identification (ID) information and additional information. The first terminal may include a display and a processor connected with the display. The processor may be configured to receive the sound wave driving signal from the second terminal, extract the driving signal from the sound wave driving signal, determine the target application among the at least one second application, based on the application ID information included in the extracted driving signal, determine whether the display is on, determine whether the first terminal is in a lock screen mode, and switch the first terminal from the lock screen mode to an unlocked mode when receiving the sound wave driving signal. As used herein, the term “lock screen mode” may refer to a mode or state in which the first user terminal 100 displays the lock screen on the display or the first user terminal 100 is locked. As used herein, the term “unlocked mode” may refer to a mode or state in which the first user terminal escapes from the lock screen mode or the lock screen is released to thus display a main screen or a home screen.

The processor may be configured to receive the sound wave driving signal while the first terminal is in the lock screen mode. The processor may be configured to stop receiving the sound wave driving signal when the display of the first terminal is turned off. The target application may be an application matching the application ID information among the at least one second application.

As set forth above, the second terminal may generate and send out the sound wave driving signal. When the first terminal is positioned within a predetermined range from the second terminal, if the first terminal is in the lock screen mode, then the first terminal may receive, via the always-on application, the sound wave driving signal from the second terminal and may thus switch from the lock screen mode to the unlocked mode (i.e., the first terminal is unlocked). For example, the predetermined range may be a range or distance in which the first terminal may receive the sound wave driving signal from the second terminal. The first terminal may extract the driving signal from the received sound wave driving signal and drive the application matching the application ID information of the driving signal, i.e., the target application. Thus, it is possible to unlock the first terminal and execute the target application by simply receiving the sound wave driving signal. The driving signal may further include additional information necessary to run, or properly operate, the target application. The additional information may be used, as necessary, when executing the target application. Thus, embodiments of the disclosure implement a further simplified way to unlock an electronic device and run applications via a sound wave driving signal.

The above-described embodiments are merely examples, and it will be appreciated by one of ordinary skill in the art various changes may be made thereto without departing from the scope of the present invention. Accordingly, the embodiments set forth herein are provided for illustrative purposes, but not to limit the scope of the present invention, and should be appreciated that the scope of the present invention is not limited by the embodiments. The scope of the present invention should be construed by the following claims, and all technical spirits within equivalents thereof should be interpreted to belong to the scope of the present invention.

What is claimed is:

1. A method for driving a target application installed on a first user terminal, the method comprising:
outputting a sound wave driving signal from a second user terminal, the sound wave driving signal including a sound wave signal and a driving signal synchronized with each other, the driving signal including application identification (ID) information and additional information;
receiving the sound wave driving signal by an always-on application installed on the first user terminal while a display of the first user terminal is in an on state and displays a lock screen;
extracting the driving signal from the sound wave driving signal; determining the target application based on the driving signal;
driving the target application based on the driving signal; and
stopping receiving the sound wave driving signal when the display of the first user terminal is turned off or the lock screen is released.

2. The method of claim 1, further comprising determining the target application by the second user terminal, generating the driving signal to drive the target application, and generating the sound wave driving signal by synthesizing the driving signal with the sound wave signal.

3. The method of claim 1, further comprising determining the target application by an online server connected with the second user terminal, generating the driving signal to drive the target application, generating the sound wave driving signal by synthesizing the driving signal with the sound wave signal, and transmitting the sound wave driving signal to the second user terminal.

4. The method of claim 1, wherein the always-on application receives the sound wave driving signal through a microphone of the first user terminal when the first user terminal is in a lock screen mode and releases the lock screen mode and drives the application based on the sound wave driving signal.

5. The method of claim 1, wherein the sound wave signal is a sound wave signal in an inaudible frequency bandwidth.

6. The method of claim 1, wherein the sound wave signal is a melody or music sound.

7. A system for driving a target application via a sound wave driving signal, the system comprising:
a first terminal having a first application and at least one second application installed thereon, the first application being an always-on application running on the first terminal while the first terminal is on, the at least one second application including the target application; and
a second terminal transmitting the sound wave driving signal to the first terminal, wherein the sound wave driving signal includes a carrier signal and a driving signal synchronized with each other, the driving signal including application identification (ID) information and additional information, wherein the first terminal includes:
a display; and
a processor connected with the display and configured to:
receive the sound wave driving signal from the second terminal;
extract the driving signal from the sound wave driving signal;
determine the target application among the at least one second application, based on the application ID information included in the extracted driving signal;
determine whether the display is on;
determine whether the first terminal is in a lock screen mode; and
switch the first terminal from the lock screen mode to an unlocked mode when receiving the sound wave driving signal.

8. The system of claim 7, wherein the processor is configured to receive the sound wave driving signal while the first terminal is in the lock screen mode.

9. The system of claim 7, wherein the processor is configured to stop receiving the sound wave driving signal when the display of the first terminal is turned off.

10. The system of claim 7, wherein the target application is an application matching the application ID information among the at least one second application.

11. The system of claim 7, wherein the processor is configured to allow the first terminal to stay in a standby mode unless the first terminal is in the lock screen mode and, when the display of the first terminal turns on to display the lock screen, release the standby mode to receive the sound wave driving signal.

12. The system of claim 11, wherein the processor is configured to turn the first terminal back to the standby mode based on at least one event of a turn-off of the display, a release of the lock screen mode, or execution of the target application.
